(19) United States
(12) Patent Application Publication
(10) Pub. No.: US 2026/0178026 A1
(43) Pub. Date: Jun. 25, 2026

(54) VEHICLE CONTROL SYSTEM

(71) Applicant: NISSAN NORTH AMERICA, INC., Franklin, TN (US)

(72) Inventor: Marcell Jose VAZQUEZ-CHANLATTE, Los Altos, CA (US)

(21) Appl. No.: 19/000,096

(22) Filed: Dec. 23, 2024

(51) Int. Cl. G05D 1/223; B60R 25/24; G05D 1/69; G05D 109/10; G05D 111/30; G05D 111/50

(52) U.S. Cl. CPC G05D 1/223; B60R 25/24; G05D 1/69; B60R 2325/103; G05D 2109/10; G05D 2111/30; G05D 2111/52

(57) ABSTRACT

A vehicle control system includes an authorization sensor, a controller and a handle. The authorization sensor is configured to receive an authorization signal. The controller is configured to enable movement of the vehicle based on the authorization signal. The handle is attachable to the vehicle and configured to enable movement of the vehicle.

### BACKGROUND

### Technical Field

The present disclosure generally relates to a vehicle control system. More specifically, the present disclosure relates to a vehicle control system that enables external vehicle control.

### Background Information

Conventional vehicle control systems enable autonomous vehicle control or partial autonomous vehicle control. Control of these vehicles is performed autonomously or partially autonomously by a vehicle control system. In these conventional control systems, the vehicle is operated based on information sensed by the vehicle and the data input into the a controller. The controller operates the vehicle based on the sensed information, positioning information or other suitable information input into the controller. Alternatively, a vehicle can be operated in the manual conventional manner by an operator inside the vehicle. The operator controls the vehicle in a conventional manner by the steering and pedals.

### SUMMARY

It has been discovered that it is desirous to be capable of operating a vehicle externally by manipulation of the vehicle control system. For example, it has been determined that autonomous or semi-autonomous vehicles can make a determination to stop or fail to proceed based on information input into the vehicle control system. In such a situation it is desirable that an operator outside of the vehicle (external operator or user) be capable of operating the vehicle. It has been further determined that movement of a vehicle by an operator outside of the vehicle is desirable in a factory or lot setting in which a vehicle is to be moved a relatively short distance.

In view of the state of the known technology, one aspect of the present disclosure is to provide a vehicle control system comprising an authorization sensor, a controller and a handle. The authorization sensor is configured to receive an authorization signal. The controller is configured to enable movement of the vehicle based on the authorization signal. The handle is attachable to the vehicle and is configured to enable movement of the vehicle.

Another aspect of the present disclosure is to provide a method of controlling a vehicle, the method comprising sensing an authorization of operation of a vehicle using a sensor, authorizing control of the vehicle via a controller in the vehicle, and using a handle attached to the vehicle to indicate direction of operation.

By providing the system and method disclosed herein, an operator is capable of moving a stopped vehicle to avoid a traffic situation or to reposition a vehicle in a lot or factory setting. Accordingly, the system improves the ease of operation of the vehicle by an external user, providing a safer or secure environment and improving the time to safely position a vehicle.

### BRIEF DESCRIPTION OF THE DRAWINGS

Referring now to the attached drawings which form a part of this original disclosure:

FIG. 1 shows a vehicle control system in a vehicle according to one embodiment of the present invention;

FIG. 2 shows the vehicle control system of FIG. 1 with the handle in the deployed position;

FIG. 3 shows a vehicle equipped the vehicle control system of FIG. 1 approaching an intersection;

FIG. 4 shows the vehicle equipped the vehicle control system of FIG. 1 stopped at the intersection due to an emergency vehicle;

FIG. 5 shows a vehicle equipped the vehicle control system of FIG. 1 in a factory or vehicle parking lot setting;

FIG. 6 shows the vehicle equipped the vehicle control system of FIG. 1 with the operational authorization being activated;

FIG. 7 shows the vehicle equipped the vehicle control system of FIG. 6 with the handle in the deployed position;

FIG. 8 shows the vehicle equipped the vehicle control system of FIG. 6 with an operator moving the vehicle by the deployed handle;

FIG. 9 shows a first embodiment of a plurality of vehicles equipped the vehicle control system of FIG. 1 with an operator moving the plurality of vehicles;

FIG. 10 shows a second embodiment of a plurality of vehicles equipped the vehicle control system of FIG. 1 with an operator moving the plurality of vehicles;

FIG. 11 is a top view of an embodiment of the handle of the vehicle control system of FIG. 1;

FIG. 12 is a side elevational view of the handle of FIG. 11;

FIG. 13 is an embodiment of the vehicle control system in which the operator can control the vehicle using hand gestures or voice; and

FIG. 14 is a flow chart illustrating a method or enabling an external user to move or operate the vehicle.

It should be noted that these figures are intended to illustrate the general characteristics of methods, structure and/or materials utilized in certain illustrative embodiments and to supplement the written description provided below. These drawings are not to scale and may not precisely reflect the precise structural or performance characteristics of any given embodiment and should not be interpreted as defining or limiting the range of values or properties encompassed by illustrative embodiments unless specified.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

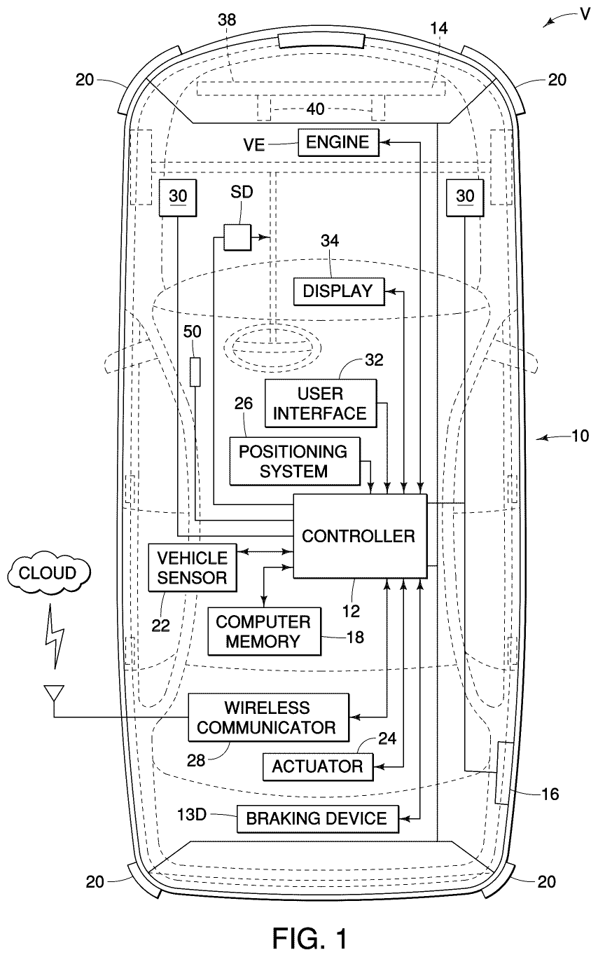

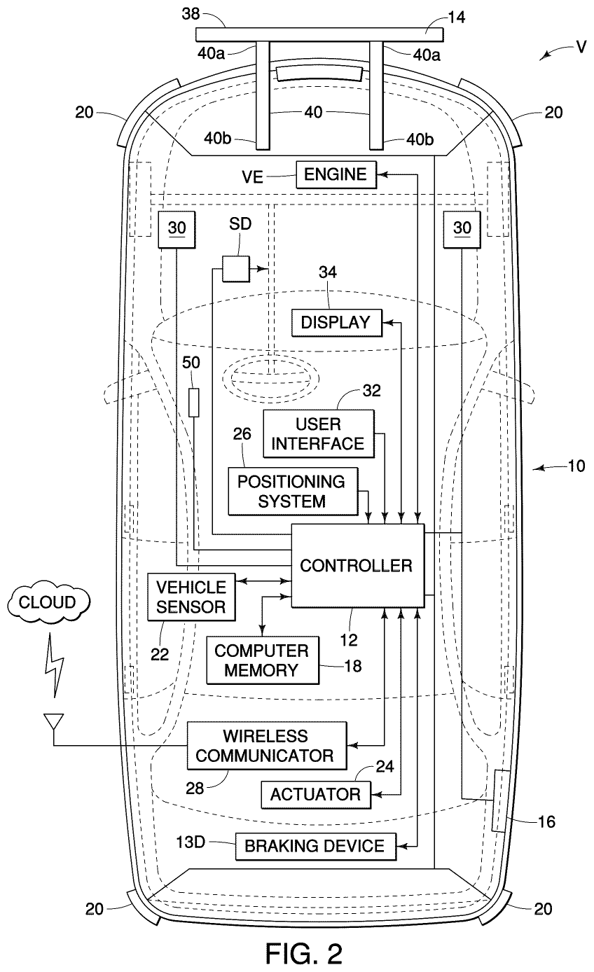

Referring initially to FIGS. 1 and 2, a vehicle control system 10 in a vehicle V is illustrated in accordance with a first embodiment. The term “vehicle control system 10” as used herein may include an autonomous driving control and a driving assist control. The autonomous driving control performs all driving tasks without human intervention, such as automatically navigating the vehicle V along a planned route without human intervention or autonomous operation based on sensors.

As can be understood, the vehicle V controlled by the vehicle control system 10 can be any suitable vehicle. Here, the vehicle V is illustrated as a sedan; however, the illustration of the sedan is merely exemplary and the vehicle V can be any suitable vehicle, including but not limited to an SUV, a truck, a pick-up truck, a sports car, a hatchback, an autonomous vehicle, a semiautonomous vehicle, or any other desired vehicle.

As also seen in FIG. 1, the vehicle V is also equipped with a vehicle engine VE and other conventional vehicle components, such as a steering device SD, a braking device BD, etc. The vehicle engine VE generates a torque output of the vehicle V in accordance with the operation of the vehicle V pedal by the driver. The torque output generated by the vehicle engine VE is then transferred to the wheels of the vehicle V through the transmission and the drivetrain of the vehicle V in a conventional manner. The vehicle engine VE can be further equipped with an electronic control unit (ECM). In particular, the ECM controls a torque output of the vehicle engine VE. In the illustrated embodiment, the vehicle engine VE can be an internal combustion engine or an electric engine. Alternatively, the vehicle V can be a hybrid vehicle V, or be operated by a hydrogen powertrain.

In the illustrated embodiment, the vehicle control system 10 includes an electronic control unit or controller 12 (e.g., a processor), a handle 14 and an authorization sensor 16. The vehicle control system 10 can also include a computer memory 18. The electronic controller 12 includes one or more processor(s) for controlling the various operations of the vehicle V, as will be further described. In the illustrated embodiment, the electronic controller 12 is preferably a microcomputer (MPU) or central processing unit (CPU). The electronic controller 12 is formed of one or more semiconductor chips that are mounted on a circuit board. The term “electronic control unit” or “electronic controller” as used herein refers to hardware that executes a software program, and does not include a human being. The MPU or CPU may be one or more integrated circuits having firmware for causing the circuitry to complete the activities described herein. Of course, any number of other analog and/or digital components capable of performing the functionality described below can be provided in place of, or in conjunction with the electronic controller 12.

The controller 12 can also include other conventional components such as an input interface circuit, an output interface circuit, and storage devices such as a ROM (Read Only Memory) device and a RAM (Random Access Memory) device. The microcomputer of the controller 12 is programmed to control the vehicle control system 10. The memory circuit stores processing results and control programs such as ones for the sensors 20, the vehicle sensor 22, the vehicle actuator 24, the positioning system 26, wireless communicator 28, the steering device SD and the braking device BD that are run by the processor circuit. The controller 12 is operatively coupled to the re the sensors 20, the vehicle sensor 22, the vehicle actuator 24, the positioning system 26, wireless communicator 28, the steering device SD and the braking device BD in a conventional manner. The internal RAM of the controller 12 stores statuses of operational flags and various control data. The internal ROM of the controller 12 stores the-information for various operations. The controller 12 is capable of selectively controlling any of the components of the vehicle control system 10 in accordance with the control program.

The computer memory 18 is any memory or storage device. Here, for example, the computer memory 18 includes a transitory or non-transitory computer-readable medium with the sole exception of a transitory propagating signal. Thus, the computer memory 18 can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The computer memory 18 stores various control processes or control programs as well as information or data used by the electronic controller 12. Thus, the computer memory 18 is electrically connected to the electronic controller 12. In this way, the electronic controller 12 can retrieve data and access programs stored in the computer memory 18, and can store data to the computer memory 18. The computer memory 18 preferably includes non-volatile memory that is configured to store various control programs (e.g., a program for a vehicle V control method, etc.), operational data, component identification data, etc.

In the illustrated embodiment, the vehicle control system 10 further includes an environmental sensors 20. The environmental sensors 20 detects the traveling environment of the vehicle V. For example, the environmental sensors 20 can be equipped with one or more unidirectional or omnidirectional external cameras that take moving or still images of the traveling environment or surroundings of the vehicle V. The environmental sensors 20 can also include infrared detectors, ultrasonic detectors, radar detectors, photoelectric detectors, magnetic detectors, acceleration detectors, acoustic/sonic detectors, gyroscopes, lasers or any combination thereof. The environmental sensors 20 can also include object-locating sensing devices including range detectors, such as FM-CW (Frequency Modulated Continuous Wave) radars, pulse and FSK (Frequency Shift Keying) radars, sonar and Lidar (Light Detection and Ranging) devices. The data from the environmental sensors 20 can be used to detect the traveling environment of the vehicle V. In any case, in the illustrated embodiment, the environmental sensors 20 include at least one of a lidar sensor (Lidar), a radar sensor (radar) and an image sensor (camera).

In the illustrated embodiment, the vehicle control system 10 further includes a vehicle sensor 22, a vehicle actuator 24, a satellite navigation device or positing system 26 a wireless communicator 28. The vehicle sensor 22 includes various sensors to detect driving states of the vehicle V. For example, the vehicle sensor 22 includes a vehicle speed sensor, a yaw rate sensor, a torque sensor, etc. The vehicle speed sensor can measure wheel speed of the vehicle V in a conventional manner to detect current vehicle speed of the vehicle V. The yaw rate sensor detects the yaw rate generated in the vehicle V in a conventional manner. The torque sensor can measure the torque on the crankshaft of the vehicle engine VE in a conventional manner.

In one embodiment, the vehicle sensor can include a plurality of inertial measurement units (IMU) 30. An IMU is an electronic device that measures and reports a force applied to the vehicle V, the angular rate of the vehicle V, and the orientation of the vehicle V, using a combination of accelerometers, gyroscopes, or any other suitable device. The IMUs 30 can detect the linear acceleration the vehicle V using one or more of the accelerometers and the rotational rate of the vehicle V using one or more of the gyroscopes. The IMUs 30 are often incorporated into or in communication with the satellite navigation device 26, which utilize the raw IMU measurements to calculate attitude, angular rates, linear velocity, and position relative to a global reference frame.

The vehicle actuator 24 is operatively connected to the electronic controller 12 to operate vehicle components of the vehicle V according to the autonomous driving control and/or the driving assist control. Specifically, the vehicle actuator 24 includes a steering actuator, a brake control actuator, etc. The steering actuator operates the steering device SD of the vehicle V to control the steering angle of the vehicle V. The brake control actuator operates the braking device BD to control the deceleration of the vehicle V. In the illustrated embodiment, the electronic controller 12 can be in communication with the ECM of the vehicle engine VE to operate the vehicle engine VE to control the acceleration of the vehicle V. However, the vehicle actuator 24 can further include an accelerator opening actuator that operates the throttle of the vehicle engine VE to control the acceleration of the vehicle V.

The satellite navigation device 26 includes a global navigation satellite system (GNSS) receiver. In the illustrated embodiment, the GNSS receiver can be a global positioning system (GPS) receiver, for example. The satellite navigation device 26 receives radio waves from a plurality of navigation satellites to obtain information that represents, for example, a current vehicle heading of the vehicle V, a current vehicle position of the vehicle in two or three dimensions, a current vehicle angular orientation of the vehicle, or a combination thereof.

The wireless communicator 28 is in wireless communications to at least one of cloud services and a vehicle network. The wireless communicator 28 is further configured to communicate with other vehicles or device as described herein to facilitate control of the vehicle V. The wireless communicator 28 is a hardware device capable of transmitting and/or receiving an analog or digital signal wirelessly via an antenna. The terms “wireless communicator” as used herein include a receiver, a transmitter, a transceiver, or a transmitter-receiver, for example.

In the illustrated embodiment, the vehicle control system 10 can be further equipped with any other vehicle components, such as a user interface 32 with a display device 24 or display screen that is configured to display various information to the driver.

The display device 34 can be a display that is capable of displaying information. As described herein, the information that is displayed can be at least one of status information of related to the vehicle V as is known in the art. Preferably, the display device 34 includes a touch screen. Thus, here, the display device functions as both the user interface 32 and a notification device. The display device can include a graphical user interface (GUI) to enable a vehicle V occupant to change settings in the vehicle V, operate the positioning system and provide any information input necessary for operation of the vehicle V and the vehicle control system 10.

The controller 12 is further in communication with the authorization sensor 16. The authorization sensor 16 is configured to receive a signal from an authorized device 36 external to the vehicle V, which enables authorization of external control by a user. In one embodiment, near field communication (NFC) can be used to communicate between the authorization sensor 16 and the authorized device 36. For example, the authorized device 36 can be a badge that is positioned adjacent the authorization sensor 16 to cryptographically authenticate control. As can be understood, NFC uses radio-frequency identification technology (known as RFID) which allows compatible hardware to both supply power to and communicate with an otherwise unpowered and passive electronic tag (e.g., the authorized device 36) using radio waves. NFC uses set of communication protocols that enables communication between the authorized device 36 and the authorization sensor 16 over a distance of 4 cm (1+½ in) or less. NFC is based on inductive coupling between two electromagnetic coils present on a NFC-enabled device such as a smartphone. NFC communicating in one or both directions uses a frequency of 13.56 MHz in the globally available unlicensed radio frequency ISM band, compliant with the ISO/IEC 18000-3 air interface standard at data rates ranging from 106 to 848 kbit/s.

In one embodiment, the authorization sensor 16 and the authorized device 36 can use KERBORUS protocol. KERBORUS is a computer-network authentication protocol that works on the basis of tickets to allow nodes communicating over a non-secure network to prove their identity to one another in a secure manner. KERBORUS provides mutual authentication—both the user and the server verify each other's identity. KERBORUS protocol messages are protected against eavesdropping and replay attacks. As can be understood, a KERBORUS type protocol can enable an expiration or limited time and/or number of uses of the authorized device 36. It is noted that KERBORUS is merely exemplary and any protocol or system that would enable limited time and/or number of uses of the authorized device 36 can be used.

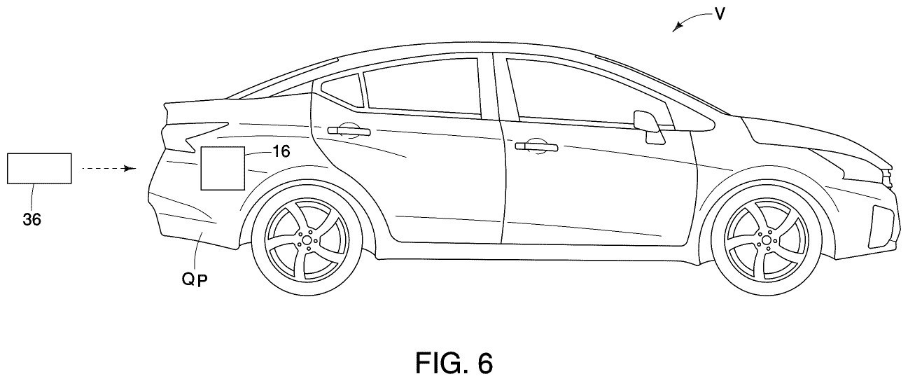

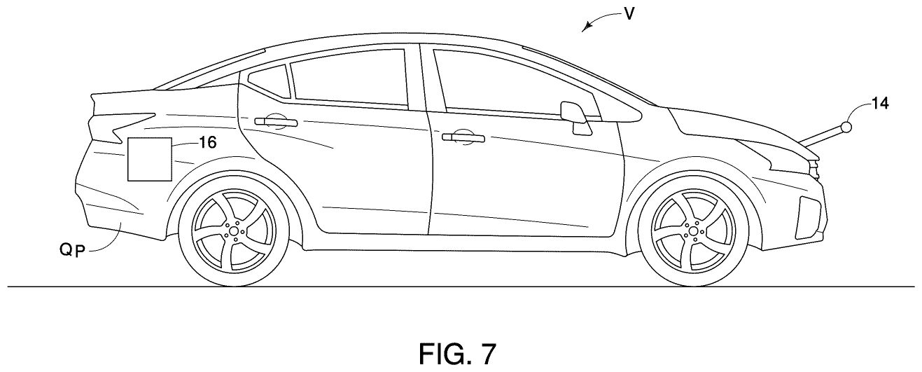

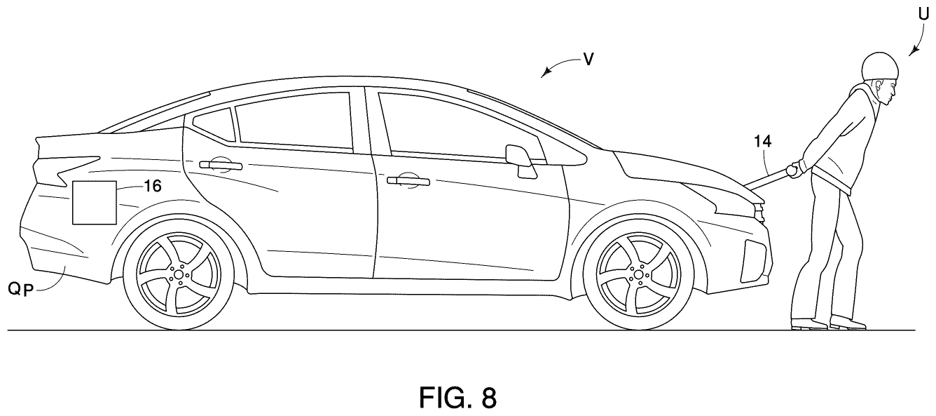

As shown in FIGS. 6 and 7, the authorization sensor 16 can positioned in the rear quarter panel QP of the vehicle V. The authorization sensor 16 can be positioned in, on or under the vehicle exterior and thus be accessible by the authorized device 36 from the exterior or the vehicle V. In one embodiment, the authorization sensor 16 is hidden from view, since it is disposed within or under the material that forms the rear quarter panel. Accordingly, to an casual observer the authorization sensor 16 is not visible. It should be understood that the authorization sensor 16 can be disposed in any desired or suitable location in or on the vehicle. Moreover, multiple authorization sensors 16 can be positioned in or on the vehicle to enable the authorized device 36 ease of access.

The handle 14 is attachable to the vehicle V and enables the external party to move or manipulate the vehicle V. The handle 14 can be metal, an alloy, a thermoplastic, carbon-fiber or any suitable material. The handle 14 has a handlebar 38 and first and second attachment legs 40. The first and second attachment legs 40 can attach to the handlebar 38 at a first end 40a and the vehicle V at a second end. The second end of the first and second attachments bars can have a suction cup that would enable a secure, removable connection to the any part of the vehicle V. The attachment bars can be tubular or rectangular or formed in any suitable manner.

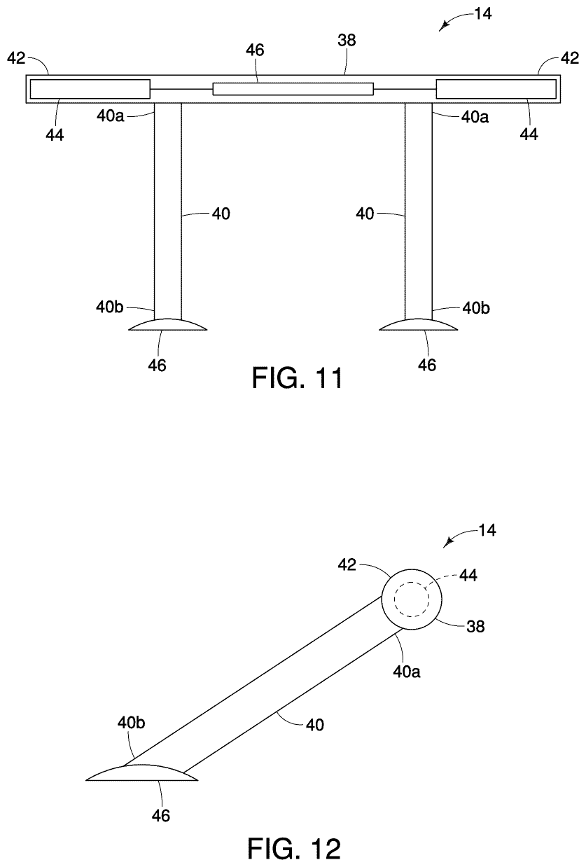

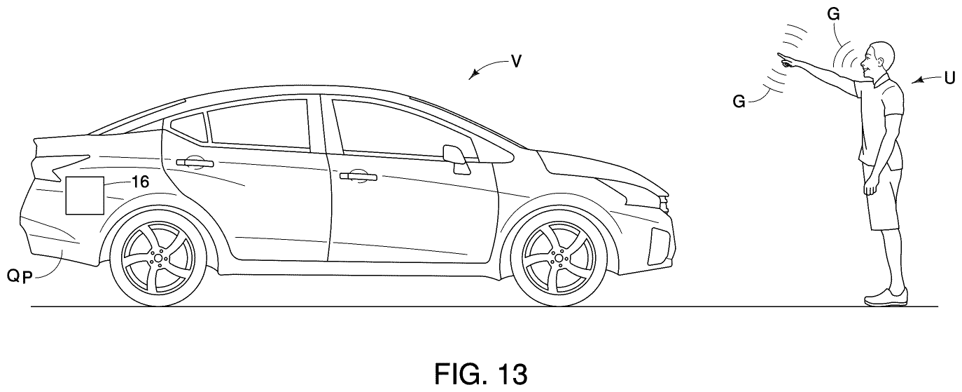

The handlebar 38 can be cylindrical and extend generally perpendicular to the first and second attachment bars. As illustrated in FIG. 11, the handlebar 38 can have grip members 42 to increase the gripping of the user and provide an ease of movement of the vehicle V. In one embodiment, the handlebar 38 can include sensors 44, such a pressure sensors in the grip members 42. In this embodiment, the pressure sensors 44 are configured to enable the user to direct the vehicle V. Here, the handlebar 38 would further include a transmitter 46 to transmit the information from the pressure sensors to the controller 12 of the vehicle control system 10. Similarly to the wireless communicator 28, the transmitter 46 is a hardware device capable of transmitting an analog or digital signal wirelessly via an antenna.

In one embodiment, the handle 14 can be detachable from the vehicle V. For example, the second ends 40b of the first and second legs can each include a suction cup 46. Thus, when external operation of the vehicle is desired. The handle can be attached and detached by an external user by the suction cups 46. It can be understood that the suction cups 46 are merely one example of a device that would enable the handle 14 to be attached to the vehicle V, and any suitable attachment device is suitable.

In another embodiment, the handle 14 is disposed within the vehicle V. See for example, FIGS. 1 and 2 in which the handle 14 is illustrated in a hidden and a deployed state. FIG. 1 illustrates the handle 14 in a hidden state in which the handle is disposed beneath the vehicle V or the hood of the vehicle V. Upon authorized use, the handle can be deployed, as described herein. In one embodiment, the handle is merely stored in the vehicle V and upon authorization, the handle 14 can be accessible, such that the external user can fix the handle to the vehicle using, for example, the suction cups. In another embodiment, the handle is affixed to the vehicle and is deployed into an operation state, as shown in FIG. 2. As can be understood, the handle can be deployed from beneath the vehicle V or from beneath the hood into an useable or operation state.

In one embodiment the authorized device 36 can be a “key” that operates a specific vehicle V. In this embodiment the authorized device 36 would only be identified by a specific controller 12 within a specific vehicle V. In another embodiment, the authorized device 36 can be a master key. For example, specific emergency personnel or factory personnel can have an authorized device 36 that is configured to operate all or a specific group of vehicles. In still yet another embodiment, the authorized device 36 can be a key which can operate a specific number (one or more) of vehicles but expire after a predetermined amount of time.

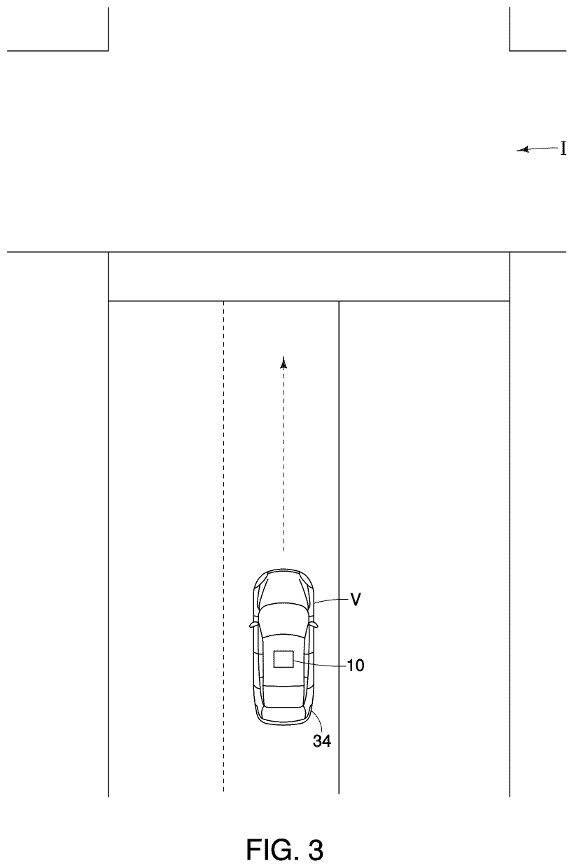

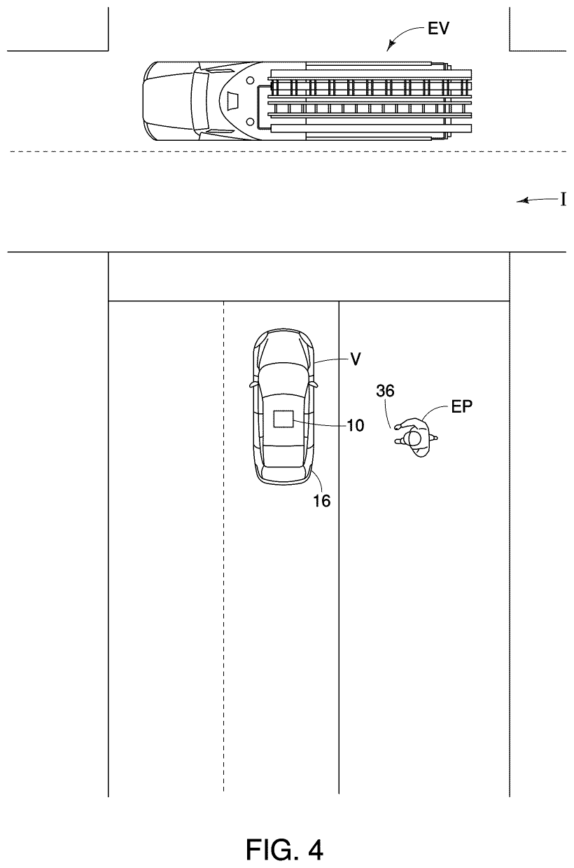

As illustrated in FIG. 3, the vehicle V can operate in a street, road or any other vehicle V appropriate situation. As the vehicle V approaches an intersection I or other environmental situation, the vehicle V may encounter another vehicle. In some situations the other vehicle V can be an emergency vehicle EV, such as a firetruck, an ambulance, a police vehicle V or any other type of emergency vehicle EV. In these situations, the vehicle V can be programmed to stop or perform another procedure to enable priority movement to the emergency vehicle EV. In the embodiment illustrated in FIGS. 3 and 4, an emergency vehicle EV (e.g., firetruck) is positioned in the intersection I and the vehicle V has stopped to enable priority access of the emergency vehicle EV to the intersection I. Here, the vehicle V lacks programming ensure movement to avoid blocking some or all of the lane the vehicle V currently occupies. In some situations, it may be desirable to move the vehicle V to ensure the safety of occupants, enable passage of other emergency vehicle or simply to move the vehicle V for any suitable reason.

In this embodiment, emergency personnel EP can approach the vehicle V. The emergency personnel can be a police officer with an authorized device 36 that enables access to external movement of the vehicle V. Here the emergency personnel EP can be considered an external user. It should be understood, that the external user does not necessarily need to be emergency personnel EP and can be any suitable external user to move the vehicle V. As illustrated in FIG. 6, and as discussed above, the authorized device 36 can be a badge that is positioned adjacent the authorization sensor 16 emergency personnel EP to cryptographically authenticate control. In this embodiment the authorized device 36 can use NFC to communicate with the authorization sensor 16 using radio waves. As described herein, the authorized device 36 and the can be a master “key” that enables the emergency personnel EP to operate all or some autonomous vehicles or semiautonomous vehicles.

The controller 12 receives an authorization signal from the authorization sensor 16 that external control of the vehicle V is desired. The controller 12 approves the external authorization and establishes an external movement state. As shown in FIG. 7, the handle 14 can be attached to the front of the vehicle V using the suction cups and enables the emergency personnel to move the vehicle V when the vehicle V is in the external movement state. In one embodiment, the handle 14 can be in an undeployed stated that is below the hood of the vehicle V, or in any other suitable position. Once the vehicle V is put in the external movement state, the handle 14 can be deployed to enable access of the handle 14 to the external emergency personnel EP. Thus, the handle 14 can be attached to the vehicle V and simply move from an undeployed state to the deployed state or the handle 14 can be exposed to enable an emergency personnel to attach the handle 14 to the vehicle V using suction cups, as described herein.

As can understood, the force exerted on the handle 14 can be transferred to the vehicle V, which using the IMUs 30 can sense the force exerted on the vehicle V. Thus the sensors can transmit a signal to the controller 12 indicating a direction of the desired movement of the vehicle V. The controller 12 can then operate the engine, the steering device SD and the braking device BD to control movement of the vehicle V by the external emergency personnel EP. For example, when the emergency personnel pulls the handlebar 38 in a forward direction this force is detected by the IMUs 30, which send a signal indicating that a force in the forward direction has been applied. The controller 12 determines that this force is a request by the external emergency personnel EP to move the vehicle V in a forward direction. Accordingly, the controller 12 operates the engine E to move the vehicle V in a forward direction at a pace indicated by the emergency personnel EP.

Similarly, when the external emergency personnel EP applies a force to the handlebar 38 indicating a left or right direction is desired, the IMUs 30 detect the force and send a signal indicating that a force in the left or right direction has been applied. The controller 12 determines that this force is a request by the external emergency personnel EP to move the vehicle V in a left or right direction. Accordingly, the controller 12 operates the steering device SD to move the vehicle V in a left or right direction at a pace indicated by the emergency personnel EP.

When the emergency personnel EP pushes against the handlebar 38 in a rearward direction this force is detected by the IMUs 30, which send a signal indicating that a force in the rearward direction has been applied. The controller 12 determines that this force is a request by the external emergency personnel EP to slow or stop the vehicle V or move the vehicle V in a rearward direction. Accordingly, the controller 12 operates the engine E to slow or stop and/or move the vehicle V in a rearward direction at a pace indicated by the emergency personnel EP. Moreover, the controller 12 can apply the braking device BD to stop the vehicle V if so desired.

Accordingly, the vehicle control system 10 can operate control of the vehicle V based on the input of the external emergency personal EP. Such a system can improve safety and access to areas for emergency vehicles EV and avoid locking of roads and other environments due to stopped vehicles.

In one embodiment, the controller 12 can simply place the vehicle V in a neutral state to enable the external emergency personnel EP to pull the vehicle V without engine operation or a combination of emergency personnel exerted force and engine operation. In this embodiment, the emergency personal EP can use the handle 14 to physically move the vehicle V using force without an assist or operation from the vehicle V.

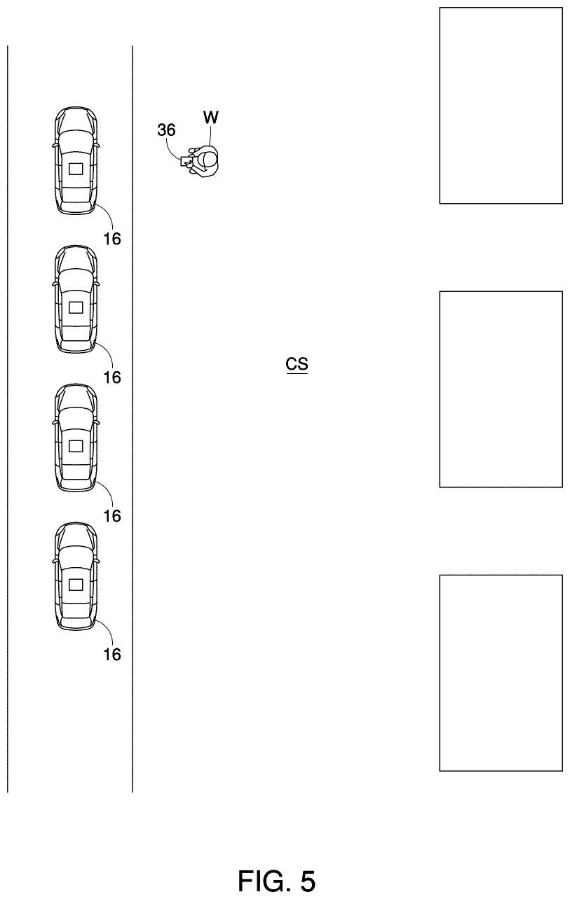

As illustrated in FIG. 5, a worker W in a commercial setting CS, such as a worker in a factory or a worker in a lot my need to or desire to move the vehicle V. Here the worker W can be considered an external user. It should be understood, that the external user does not necessarily need to be a worker W and can be any suitable external user to move the vehicle V. In such a situation, as illustrated in FIG. 6, and as discussed above, the authorized device 36 can be a badge that is positioned adjacent the authorization sensor 16 to cryptographically authenticate control. In this embodiment the authorized device 36 can use NFC to communicate with the authorization sensor 16 using radio waves.

The controller 12 receives an authorization signal from the authorization sensor 16 that external control of the vehicle V is desired. The controller 12 approves the external authorization and establishes an external movement state. As shown in FIG. 7, the handle 14 can be attached to the front of the vehicle V using the suction cups and enables the worker W to move the vehicle V when the vehicle V is in the external movement state. In one embodiment, the handle 14 can be in an undeployed stated that is below the hood of the vehicle V, or in any other suitable position. Once the vehicle V is put in the external movement state, the handle 14 can be deployed to enable access of the handle 14 to an external worker W. Thus, the handle 14 can be attached to the vehicle V and simply move from an undeployed state to the deployed state or the handle 14 can be exposed to enable a worker W to attach the handle 14 to the vehicle V using suction cups.

As can understood, the force exerted on the handle 14 can be transferred to the vehicle V, which using the IMUs 30 can sense the force exerted on the vehicle V. Thus the sensors can transmit a signal to the controller 12 indicating a direction of the desired movement of the vehicle V. The controller 12 can then operate the engine E, the steering device SD and the braking device BD to control movement of the vehicle V be the external worker W. For example, when the worker W pulls the handlebar 38 in a forward direction this force is detected by the IMUs 30, which send a signal indicating that a force in the forward direction has been applied. The controller 12 determines that this force is a request by the external worker W to move the vehicle V in a forward direction. Accordingly, the controller 12 operates the engine E to move the vehicle V in a forward direction at a pace indicated by the worker W.

Similarly, when the external worker W applies a force to the handlebar 38 indicating a left or right direction is desired, the IMUs 30 detect the force and send a signal indicating that a force in the left or right direction has been applied. The controller 12 determines that this force is a request by the external worker W to move the vehicle V in a left or right direction. Accordingly, the controller 12 operates the steering device SD to move the vehicle V in a left or right direction at a pace indicated by the worker W.

When the worker W pushes against the handlebar 38 in a rearward direction this force is detected by the IMUs 30, which send a signal indicating that a force in the rearward direction has been applied. The controller 12 determines that this force is a request by the external worker W to slow or stop the vehicle V or move the vehicle V in a rearward direction. Accordingly, the controller 12 operates the engine E to slow or stop and/or move the vehicle V in a rearward direction at a pace indicated by the worker W. Moreover, the controller 12 can apply the brakes to stop the vehicle V if so desired.

Accordingly, the vehicle control system 10 can operate control of the vehicle V based on the input of the external worker W. Such a system can improve safety and access to areas within the commercial setting CS and avoid blocking of areas in the commercial setting due to stopped vehicles. The system can also improve efficiency by enabling the external worker W to externally move a vehicle.

In one embodiment, the controller 12 can simply place the vehicle V in a neutral state to enable the external worker W to pull the vehicle V without engine operation or a combination of worker W exerted force and engine operation. In this embodiment, the external worker W can use the handle 14 to physically move the vehicle V using force without an assist or operation from the vehicle V.

In one embodiment, as shown in FIGS. 11, and 12 and as described above, the handle 14 includes sensors 44, such a pressure sensors in the grip members 42. In this embodiment, the pressure sensors 44 are configured to enable the user to direct the vehicle V. Here, the handlebar 38 transmitter 46 transmits the information from the pressure sensors 44 to the controller 12 of the vehicle control system 10. That is, the force exerted on the handlebar 38 can be transmitted to the wireless communicator of the vehicle V, which transmits a signal to the controller 12 indicating a direction of the desired movement of the vehicle V. The controller 12 can then operate the engine E, the steering device SD and the braking device BD to control movement of the vehicle V by the external emergency personnel EP or the external worker W or any other suitable external user. For example, when the emergency personnel pulls the handlebar 38 in a forward direction this force is detected by pressure sensors 44 in the handlebar 38, which sends a signal indicating that a force in the forward direction has been applied. The controller 12 determines that this force is a request by the external user to move the vehicle V in a forward direction. Accordingly, the controller 12 operates the engine E to move the vehicle V in a forward direction at a pace indicated by the external user.

Similarly, when the external user applies a force to the handlebar 38 indicating a left or right direction is desired, the pressure sensors 44 detect the force and send a signal indicating that a force in the left or right direction has been applied. The controller 12 determines that this force is a request by the external user to move the vehicle V in a left or right direction. Accordingly, the controller 12 operates the steering device SD to move the vehicle V in a left or right direction at a pace indicated by the external user.

When the external user pushes against the handlebar 38 in a rearward direction this force is detected by the pressure sensos 44, which send a signal indicating that a force in the rearward direction has been applied. The controller 12 determines that this force is a request by the external user to slow or stop the vehicle V or move the vehicle V in a rearward direction. Accordingly, the controller 12 operates the engine E to slow or stop and/or move the vehicle V in a rearward direction at a pace indicated by the external user. Moreover, the controller 12 can apply the braking device BD to stop the vehicle V if so desired.

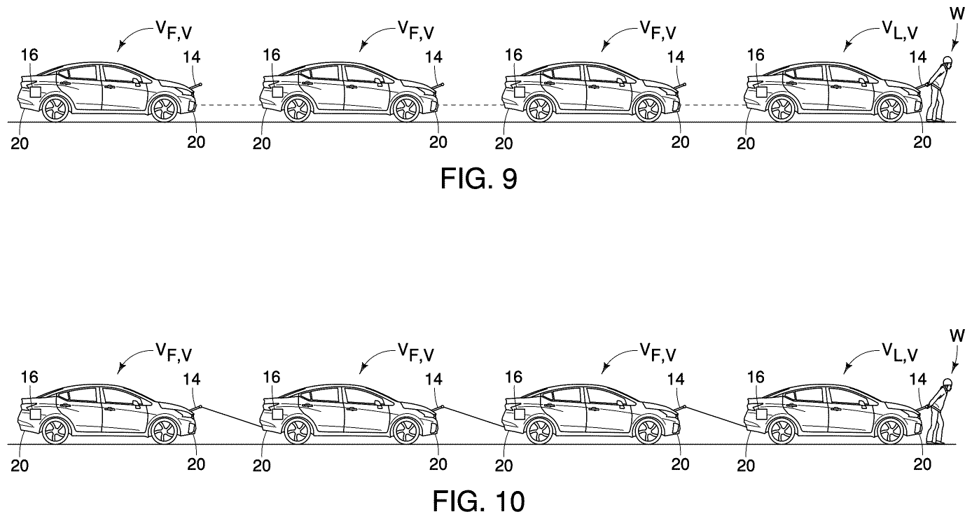

FIGS. 9 and 10 illustrate an embodiment in which the external user (e.g., worker 20) is capable of moving a plurality of vehicles V at one time. As shown in FIG. 9, there is a lead vehicle V_{L} and a series of following vehicles V_{F}. In this embodiment, the external user provides authentication to the lead vehicle V_{L}. The controller 12 receives an authorization signal from the authorization sensor 16 that external control of the lead vehicle V_{L} is desired. The controller 12 approves the external authorization and establishes an external movement state.

The lead vehicle V_{L} can transmit a signal with the wireless communicator 28 indicating that it has been authenticated for movement and requests confirmation of other vehicles V that have been authenticated. Since the lead vehicle V_{L} is the first vehicle V authenticated, there are no other vehicles authenticated. The lead vehicle V_{L} then enters a lead vehicle state. The handle 14 is then attached or deployed by the lead vehicle V_{L}.

The following vehicles V_{F} can then be authenticated. The controller 12 in each of the following vehicles V_{F} receives an authorization signal from the authorization sensor 16 that external control of the following vehicle V_{F} is desired. The controller 12 approves the external authorization and establishes an external movement state.

Moreover, upon authentication, each of the following vehicles V_{F} transmits a signal with the wireless communicator 28 indicating that it has been authenticated for movement and requests confirmation of other vehicles V that have been authenticated. Since the lead vehicle V_{L} has been authenticated, the following vehicles V_{F} enter a following vehicle state. As can be understood, preferably each following vehicle V_{F} is authenticated in the order of following and is thus capable of detecting the closet vehicle V and enters a following vehicle state in which each of the following vehicles V_{F} will follow the lead vehicle V_{L} immediately in front or another following vehicle V_{F}.

In one embodiment, the following vehicles V_{F} use the sensors 20 to determine distance and direction of the vehicle V in front. As described herein, the environmental sensors 20 can include object-locating sensing devices including range detectors, such as FM-CW (Frequency Modulated Continuous Wave) radars, pulse and FSK (Frequency Shift Keying) radars, sonar and Lidar (Light Detection and Ranging) devices. The data from the environmental sensors 20 can be used to detect the traveling environment of the vehicle V. In this embodiment, the traveling environment of the following vehicles V_{F} include the distance, location and direction of the vehicle V immediately in front of the following vehicles V_{F}, and thus the vehicle control system 10 can operate each of the following vehicles V_{F} to following the lead vehicle V_{L}. In other words, when the external user moves the lead vehicle V_{L} using the vehicle V movement methods described herein, the lead vehicle V_{L} will move as described by operation of the vehicle control system 10.

The following vehicle V immediately behind the lead vehicle V_{L} will use the sensors 20 to detect the lead vehicle V_{L} direction and movement and will operate the engine, the steering actuator and the braking system to operate the following vehicle V to provide a uniform distance to the lead vehicle V_{L}. Each subsequent following vehicle V will operate the engine, the steering actuator and the braking system of a respective following vehicle V to operate the following vehicle V to provide a uniform distance to the following vehicle V immediately in front. This enables a series of vehicle Vs to be moved based on the movement of the lead vehicle V_{L}.

Accordingly, the vehicle control system 10 can enable operation and control of a plurality of vehicles V based on the input of the external user. Such a system can improve safety and access to areas and avoid blocking of areas due to stopped vehicles. The system can also improve efficiency by enabling the external users to externally move a plurality of vehicles V.

As illustrated in FIG. 10, the external user (e.g., external worker W) authenticates each vehicle V in the series of vehicles. In this embodiment, each vehicle V is physically connected to the vehicle V immediately in front. Similarly to FIG. 9, there can be a lead vehicle V_{L} and at least one following vehicle V_{F}. Thus, when the external user moves the lead vehicle V_{L} using the vehicle V movement methods described herein, the lead vehicle V_{L} will move as described herein. In other words, when the external user moves the lead vehicle V_{L} using the vehicle V movement methods described herein, the lead vehicle V_{L} will move as described by operation of the vehicle control system 10.

The physical connection between the lead vehicle V_{L} and the following vehicle Vs will cause a force to be applied to a respective handle 14 of the following vehicles V_{F}. The handles 14 will then transmit using the force applied to the vehicle V such that each respective controller 12 will determine the movement and direction of each subsequent following vehicle V_{F}. This enables a series of vehicle Vs to be moved based on the movement of the lead vehicle V_{L}.

The determination of the force applied to the handle 14 for the lead vehicle V_{L} and the subsequent following vehicles V_{F} can be in any manner suitable. For example, the IMUs 30 of each vehicle can determine the fore applied to the vehicles V. In such an embodiment, the IMUs transmit the force applied to the controller as described herein Alternatively, the force applied to the handles 14 can be determined by the sensors 44 in the handle. This force can e transmitted to the controller 12, as described herein. In ether embodiment, the controller 12 enables the vehicle control system to move the vehicles based on a force applied by an external user.

As illustrated in FIG. 11, gesturing G can be used to direct the vehicle V. As can be understood, gesturing G can be voice gesturing, hand gesturing or any other suitable gesturing. The gesturing enables the vehicle V to be moved by an external user U. Here, the external user U uses the authorized device 36 to place the vehicle V in the movement state. S shown in FIG. 6. The external user U can then gesture a direction or specific movement for the vehicle V. The gesturing G can be sensed by the sensors 20. The sensors 20 transmits the information to the controller 12, which then determines the direction of movement indicated by the gesturing G. The controller 12 then operates the engine E, the steering device SD and the braking device BD of the vehicle V to operate the vehicle V as indicted by the external user U.

Accordingly, in one embodiment, the external user U can point to a direction for the vehicle V to move. Here, the sensors 20 can include a camera that detects the image of the external user U pointing. The image is transmitted to the controller 12 which then determines that the external user U has indicated a specific direction in which the vehicle V is to be moved. The controller 12 then operates the engine E, the steering device SD and the braking device BD of the vehicle V to operate the vehicle V as indicted by the external user U.

Accordingly, the vehicle control system 10 can enable operation and control of the vehicle V based on the input of the external user U. Such a system can improve safety and access to areas and avoid blocking of areas due to stopped vehicles. The system can also improve efficiency by enabling the external user U to externally move a vehicle V.

In another embodiment, the external user can state a direction in which the vehicle V is to move. Here, the sensors 20 can include a microphone 50 that detects the sound of the external user U stating the direction to move. The sound is transmitted to the controller 12 which then determines that the external user U has indicated a specific direction in which the vehicle V is to be moved. The controller 12 then operates the engine E, the steering device SD and the braking device BD of the vehicle V to operate the vehicle V as indicted by the external user U.

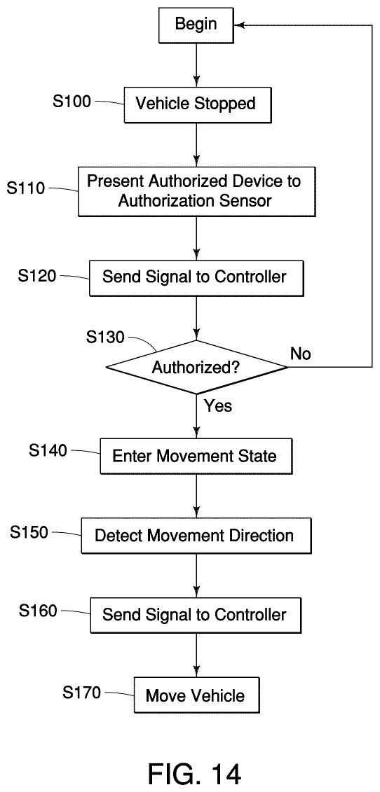

FIG. 14 illustrates the procedure for moving a vehicle V. In step S100, the vehicle V has stopped or is in a stopped state. In step S110, the external user presents the authorized device 36 to the authorization sensor 16. In step S120, the authorization signal is sent to the controller 12. In step S130, the controller 12 determines if the authorization signal is proper. If the authorization signal is not proper (No), the vehicle V remains in the stopped state and the procedure returns to the beginning.

If the authorization signal is proper, the vehicle V enters the movement state, in step S140, which state enables the vehicle V to be moved in by the external user. Here the handle 14 can be deployed or attached to the vehicle V,. The user then applies pressure to handle 14 to move the vehicle V. In step S150, the pressure is detected by the pressure sensors in the handlebar 38 and/or by the IUMs and/or in any other suitable manner. In step S160, the information related to movement of the vehicle V is transmitted via a signal to the controller 12. In step S170, the vehicle V is moved. As discussed herein, the vehicle V can be moved by the controller 12 operating the engine E, the steering device SD and the braking device BD of the vehicle V.

As can be understood, the controller 12 is configured to communicate with the various aspects of the operation of the vehicle V. In other words, the controller 12 is capable of operating the autonomous or partially autonomously, such that the controller 12 can operate the vehicle V in a forward or rearward direction and manipulate the wheels, such that the vehicle V is capable of turning while moving in the forward or rearward direction. The controller 12 can operate the vehicle V in this manner while a driver is present or while the vehicle V is empty. Thus, as described herein the controller 12 can operate the vehicle V based on external instructions from an operator.

By providing the system and method disclosed herein, an external operator is capable of moving a stopped vehicle to avoid a traffic situation or to reposition a vehicle in a lot or factory setting. Accordingly, the system improves the ease of operation of the vehicle by an external user, providing a safer or secure environment and improving the time to safely position a vehicle.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle control system. Accordingly, these terms, as utilized to describe the present invention should be interpreted relative to a vehicle equipped with the vehicle control system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle control system comprising:
a authorization sensor configured to receive an authorization signal;
a controller configured to enable movement of the vehicle based on the authorization signal; and
a handle attachable to the vehicle and configured to enable movement of the vehicle.

2. The vehicle control system according to claim 1, wherein
the sensor is configured to receive near filed communication.

3. The vehicle control system according to claim 1, further comprising at least one directional sensor configured to sensor a movement direction indicated by the handle.

4. The vehicle control system according to claim 3, wherein the at least one directional sensor is an internal measurement unit.

5. The vehicle control system according to claim 1, wherein the controller is configured to operate a motor of the vehicle to move the vehicle in a forward or reverse direction.

6. The vehicle control system according to claim 1, wherein the handle is detachable from the vehicle.

7. The vehicle control system according to claim 1, wherein the handle includes a suction cup to attach the handle to the vehicle.

8. The vehicle control system according to claim 1, wherein the handle is attached to the vehicle and is capable of being deployed from a first position to a second position.

9. The vehicle control system according to claim 1, wherein the handle includes a sensor and a transmitter, the transmitter being configured to transmit information from the sensor to the vehicle to control the vehicle.

10. The vehicle control system according to claim 9, wherein the sensor in the handle is at least one of a pressure or a stress sensor.

11. The vehicle control system according to claim 1, wherein the vehicle is a first vehicle of a plurality of vehicles and the vehicle control system is configured to enable control of the plurality of vehicles.

12. A method of controlling a vehicle, the method comprising:
sensing an authorization of operation of a vehicle using a sensor;
authorizing control of the vehicle via a controller in the vehicle; and
using a handle attached to the vehicle to indicate direction of operation.

13. The method according to claim 12, wherein
the sensor is configured to receive near filed communication.

14. The method according to claim 12, further comprising sensing via a directional sensor a movement direction indicated by the handle.

15. The method according to claim 14, wherein the directional sensor is an internal measurement unit.

16. The method according to claim 12, further comprising detaching the handle from the vehicle.

17. The method according to claim 12, further comprising attaching the handle to the vehicle with a suction cup.

18. The method according to claim 12, further comprising deploying the handle from a first position to a second position.

19. The method according to claim 1, wherein the handle includes a sensor and a transmitter, and transmitting via the transmitter being information from the sensor to the vehicle to control the vehicle.

20. The method according to claim 19, wherein the sensor in the handle is at least one of a pressure or a stress sensor.
